(19) United States
(12) Patent Application Publication
(10) Pub. No.: US 2005/0025474 A1
(43) Pub. Date: Feb. 3, 2005

(54) Signal processing device

(75) Inventor: Shuji Ono, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/902,023

(22) Filed: Jul. 30, 2004

(30) Foreign Application Priority Data
Aug. 1, 2003 (JP) 2003-205309

(51) Int. Cl. G03B 17/24

(52) U.S. Cl. 396/311

(57) ABSTRACT

There is provided a signal processing device including: a first interface for connecting the signal processing device to a device serving as a supply source for digital data; a processing unit for processing the digital data; a second interface for connecting the signal processing device to a device serving as a supply destination for the processed digital data; and an emulating unit for emulating the device serving as the supply source of the digital data, whereby a user can perform desired processing on digital data such as image data by a simple operation without being aware of the processing.

### BACKGROUND OF THE INVENTION

The present invention belongs to a technical field of digital data processing, such as image processing of images (image data) photographed by a digital camera. More specifically, the present invention relates to a signal processing device by which a user can readily perform desired processing on digital data such as image data without being aware of the processing.

An image (image data) photographed by a digital camera is usually captured by a personal computer (PC) or the like, and, for example, outputted as a print by a printer or the like connected to the PC.

Here, the image photographed by the digital camera or the like is not necessarily a proper image. Thus, in order to obtain a satisfactory image, it is necessary to perform correction of color and density and the like.

Image correction on the PC is performed by starting image processing software, and adjusting the image color, density and size on the image processing software. However, in order to perform proper image correction on the PC using the image processing software, a certain degree of knowledge and experience are necessary, and a laborious work is also required.

Moreover, when a large number of images are to be processed, it is basically necessary to set image processing for all the images on which the image processing is to be performed even if the same image processing is to be performed for all the images.

On the other hand, in recent years, a printer called a direct printer has become commercially practical. The “direct printer” is a printer to which a digital camera is directly connected, or a storage medium storing image data of an image photographed with the digital camera is directly attached, which performs predetermined image processing on the image data read out from the digital camera or from the storage medium, and which can then output the image data as prints. By using the direct printer, a user can obtain without any laborious processing, a print on which a proper image is reproduced after image processing has been performed.

However, the image processing performed by the direct printer is predetermined, and the user cannot select specific image processing. Furthermore, image processing is often automatically performed even if the user does not desire it. Thus, the most appropriate image for the user is not necessarily obtained.

### SUMMARY OF THE INVENTION

An object of the present invention is to solve the problems in the above-mentioned conventional techniques, and provide a signal processing device, serving as a digital data processing device such as an image processing device that performs image processing on, for example, image data photographed by a digital camera and by which a user can perform desired processing on digital data such as image data by a simple operation without being aware of the processing.

In order to achieve the above object, according to a first aspect of the present invention, there is provided a signal processing device, including: a first interface for connecting the signal processing device to a first device serving as a supply source of digital data; processing means for performing processing on the digital data; a second interface for connecting the signal processing device to a second device serving as a supply destination of the digital data; and emulating means for emulating the first device.

In the signal processing device according to the first aspect of present invention, it is preferable to inclde means for recognizing the first device; and means for sending information on the recognized first device to the second device, wherein a graphical user interface for operating a system to which the signal processing device is connected displays a file structure by a hierarchy conforming to a sequence in which the first device, the signal processing device and the second device are connected. Further, it is preferable that in response to one of drag-and-drop on the graphical user interface and a data readout instruction given using the graphical user interface, said processing means performs the processing on the digital data. Further, it is preferable that the processing means does not perform the processing on the digital data for which a predetermined operation was performed at a time of one of the drag-and-drop and the data readout instruction. Further, it is preferable that the graphical user interface for operating a system to which the signal processing device is connected displays only a file structure of a device arranged most upstream in a direction in which the digital data is sent. Further, it is preferable that in response to one of drag-and-drop on the graphical user interface and a data readout instruction given using the graphical user interface, said processing means performs the processing on the digital data. Further, it is preferable that the processing means does not perform the processing on the digital data for which a predetermined operation was performed at a time of one of the drag-and-drop and the data readout instruction. Further, it is preferable that the processing on the digital data comprises at least one of a treatment performed on the digital data, and addition of information to the digital data according to results of analysis of the digital data. Further, it is preferable to inclde means for downloading processing software for the digital data from an external unit, wherein said processing means uses the processing software to perform the processing on the digital data. Furthermore, it is preferable to include mounting means for enabling a storage medium to be mounted and removed, wherein said processing means uses information stored in the storage medium to perform the processing on the digital data.

Further, according to a second aspect of present invention, there is provided a signal processing device, including: a mounting unit for a storage medium that stores digital data; an insertion unit for inserting the signal processing device into a slot which is provided to an external device and which corresponds to a storage device that is based on a standard different from said mounting unit; processing means for reading out the digital data from the storage unit mounted on said mounting unit and performing processing on the read-out digital data; means for outputting the processed digital data to said insertion unit; and means for emulating the storage medium mounted on said mounting unit.

In the signal processing device according to the second aspect of the present invention, it is preferable that file structure of the storage medium is displayed on a graphical user interface for operating a system into which the insertion unit is inserted. Further, it is preferable that in response to one of drag-and-drop on the graphical user interface and a data readout instruction given using the graphical user interface, said processing means performs the processing on the digital data. Further, it is preferable that the processing means does not perform the processing on digital data for which a predetermined operation was performed at a time of one of the drag-and-drop and the data readout instruction. Further, it is preferable that the processing on the digital data includes at least one of a treatment performed on the digital data, and addition of information to the digital data according to results of analysis of the digital data. Further, it is preferable to include means for downloading processing software for the digital data from an external unit, wherein said processing means uses the processing software to perform the processing on the digital data. Furthermore, it is preferable to include mounting means for enabling the storage medium to be mounted and removed, wherein said processing means uses information stored in the storage medium to perform the processing on the digital data.

According to the signal processing device of the present invention, a user can perform desired processing on digital data such as image data by a simple operation without being aware of the processing even when a large number of data is to be processed.

This application claims priority on Japanese patent application No.2003-205309, the entire contents of which are hereby incorporated by reference.

### BRIEF DESCRIPTION OF THE DRAWINGS

In the accompanying drawings:

FIG. 1A shows a conceptual diagram of an embodiment of a signal processing device of the present invention;

FIGS. 1B and 1C are conceptual diagrams showing examples in which the signal processing device shown in FIG. 1A is used;

FIGS. 2A and 2B are conceptual diagrams for illustrating examples of operations of the signal processing device of the present invention; and

FIG. 3 is a conceptual diagram showing another embodiment of the signal processing device of the present invention.

### DETAILED DESCRIPTION OF THE PREFERRED EMBODIMENTS

The signal processing device of the present invention is described below in detail with reference to preferred embodiments shown in the attached drawings.

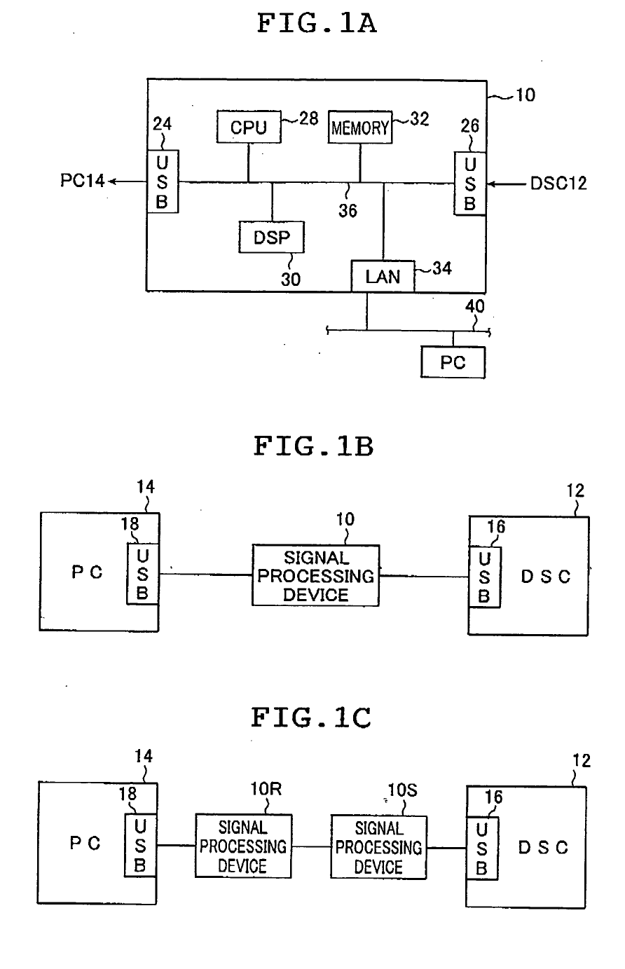

FIG. 1A is a conceptual diagram of an embodiment of a signal processing device in accordance with the present invention, and FIG. 1B is a conceptual diagram of an example in which the signal processing device of the present invention is used. A signal processing device 10 of the present invention is used as an image processing device in the example shown in FIG. 1B. A digital camera (hereinafter simply referred to as “DSC”) 12 and a personal computer (hereinafter simply referred to as “PC”) 14 are interconnected via the signal processing device 10 of the present invention. In this embodiment, when an image (image data) is sent from the DSC 12 to the PC 14, the signal processing device 10 arranged therebetween performs predetermined processing on the image data.

In an example, the signal processing device 10, the DSC 12, and the PC 14 are all compatible with USB (Universal Serial Bus), and the USB I/F (interface) is used for connection.

The USB interface is not the sole method for connecting the signal processing device 10 of the present invention to various devices. Any type of interface is usable, so long as the devices interconnected are compatible with the interface used.

The DSC12 is of an ordinary type that has a USB port 16 and is compatible with the USB mass storage class. Therefore, when connected to an external device by the USB, the DSC 12 enters a storage mode and functions as a data (image data) storage device.

The PC 14 is also of an ordinary type that has a USB port 18 and is compatible with the USB. A driver (device driver) for making the PC 14 compatible with the signal processing device 10 of the present invention may be installed if necessary to the PC 14 (device which receives data via the signal processing device of the present invention).

As shown in FIG. 1A, the signal processing device 10 includes USB ports 24 and 26 for connecting to external devices by the USB, a CPU 28 for controlling the signal processing device 10 and processing image data, a DSP (Digital Signal Processor) 30 for performing image processing, a memory 32 for temporarily storing image data, a LAN port 34 for connecting to an external network 40 or the like, and a bus 36 for interconnecting those components. A DRAM or the like is used for the memory 32.

As described above, the signal processing device 10 performs processing on image data sent from the DSC 12, by means of the DSP 30 and the CPU 28 and then sends the processed image data to the PC 14. Furthermore, the signal processing device 10 temporarily stores the image data in the memory 32 as needed.

Furthermore, the signal processing device 10 has a function of emulating an image data supply source device (a device from which the signal processing device 10 receives image data, in other words, a device connected to the signal processing device 10 upstream in the direction in which image data is transmitted (hereinafter simply referred to as “upstream”)), and a function of recognizing an upstream device connected to the signal processing device 10. Therefore, in the illustrated case, the signal processing device 10 recognizes that the device 10 is connected to the DSC 12 on the upstream side, and emulates the DSC 12.

The above points are described in detail below.

No particular restrictions are made regarding the processing that the signal processing device 10 performs on image data. Examples include image setup (gradation correction, color/density correction, and other image adjustments), image size conversions (electronic magnification), dodging processing (density dynamic range compression maintaining gray levels), sharpness processing (sharpness correction), red-eye correction, electronic watermarks and other code embedding, image data compression/decompression, image format conversion, and other types of image processing.

Furthermore, the processing that the signal processing device 10 performs on image data is not limited to the above image processing (image data treatments).

For example, the signal processing device 10 may perform image analysis on supplied image data and add various information obtained from the analysis to the image data. As a specific example, the signal processing device 10 may perform face detection and then add information indicating whether or not a person is present, information about the number of persons, information about a person's location, and the like. The signal processing device 10 may also perform person detection and recognition, search a connected database or the like, and add the person's name, email address, or the like. Red-eye detection may be further performed to add information about the presence/absence of red eyes (to warn when red-eye effect occurs) and the location of the red eyes. These pieces of information can be added to image data by selecting a usable area in accordance with the corresponding image file format and recording on the selected usable area, for example by recording on a private tag in the case of an Exif image file.

By adding these various kinds of information to the image data, the device such as the PC 14 to which the image data is sent from the signal processing device 10 of the present invention, can arbitrarily utilize these information for various applications. Addition of the information allows the added value of the image data processed by the signal processing device 10 of the present invention to be increased.

The added information is used for example for automatically determining trimming areas and enlargement/reduction when creating a slideshow or an electronic album, for automatically determining the number of prints, for automatically determining a destination to which a print (image) is to be supplied, and for obtaining information about red-eye, so that loads placed on the processing and operations by the PC 14 or the like can be reduced.

The image data processing described above may be performed by any known method.

In light of processing speed and the degree of flexibility for the selection of a specific processing step by a user, the signal processing device 10 of the present invention preferably performs one or two types of processing. However, this is not the sole case of the present invention. Three or more types of processing may be performed in accordance with the throughput, the capacity of the memory 32 and the like.

In a preferable embodiment, the signal processing device 10 is configured to be connected to an external PC through the LAN port 34 so that software such as image processing software can be downloaded to change image processing to be performed without the need for changing hardware, thereby coping with various types of processing.

Alternatively, the LAN port 34 may be replaced by a USE port so that software can be downloaded through the USB port. The USB port 26 for connecting the device 10 to the DSC 12 may also be used for software downloading.

Accordingly, the versatility and convenience of the signal processing device 10 of the present invention can be enhanced while reducing device costs.

The configuration in which software is downloaded as described above is not the sole configuration used in the signal processing device 10 of the present invention.

For example, the signal processing device 10 may have a slot for installing an ROM for use in software storage so that the ROM or the like can be installed in the slot to execute image processing stored on the ROM. This configuration may also be capable of various types of image processing by replacing an ROM with another. The signal processing device 10 may have a slot for mounting not an ROM but a cartridge having the ROM on which software is stored.

Alternatively, the signal processing device 10 of the present invention may be entirely specialized for a specific type of image processing, and the type of image processing to be performed may be impossible to change.

Hereinafter, the signal processing device 10 of the present invention is described below in further detail by referring to the operation of the system shown in FIG. 1B.

As described above, the DSC 12 and the PC 14 in the illustrated case are interconnected by the USB through the signal processing device 10 of the present invention. In other words, the signal processing device 10 of the present invention is interposed between the DSC 12 and the PC 14 which are interconnected by the USB.

The DSC 12 is compatible with the USB mass storage class, as described above. Therefore, when the DSC 12 is connected to the PC 14 by the USB, the DSC 12 enters the storage mode and functions as a data storage device. Further, the DSC 12 is recognized from the PC 14 side as one external storage device. Therefore, file (image data) transfer can be performed between the DSC 12 and the PC 14 by the operation on the PC 14 such as drag-and-drop operation.

The USB mass storage class is not the sole case of the present invention. The present invention is also advantageously compatible with a system where a driver corresponding to an image data supply source such as the DSC is installed on an image data supply destination such as the PC 14 to allow a file to be transferred by the drag-and-drop or other operations.

The signal processing device 10 that is interposed between the DSC 12 and the PC 14 has a function of recognizing and emulating the DSC 12 that is connected upstream. When the DSC 12 and the PC 14 are interconnected, the signal processing device 10 recognizes and emulates the upstream DSC 12, and also sends to the PC 14 information indicating that the DSC 12 is connected to the PC 14.

Therefore, even when the signal processing device 10 is interposed between the DSC 12 and the PC 14 as shown, the PC 14 does not recognize that some device has been interposed therebetween, but simply recognizes that the DSC 12, namely an external storage device has been connected to the PC 14.

As a preferable example of this embodiment, the signal processing device 10 hides itself in a file system of the DSC 12 (external storage device), and folders, image files and the like are displayed by a hierarchy conforming to the sequence in which connections were made, on the display (GUI (Graphical User Interface)) of the PC 14 (i.e., the device operating the system that includes the signal processing device 10 of the present invention).

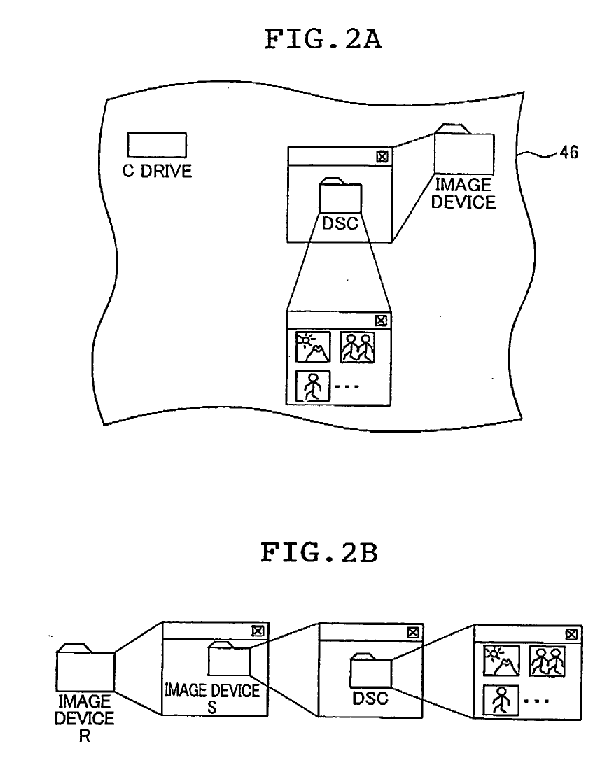

Specifically, when the DSC 12, the signal processing device 10 and the PC 14 are interconnected, a folder corresponding to the signal processing device 10 (the folder is named [ImageDevice] for sake of convenience) is displayed on a display 46 of the PC 14, as schematically shown in FIG. 2A. When the folder [ImageDevice] is opened, the DSC 12 is displayed as a folder, and when the DSC folder is opened, image files stored in the storage medium mounted on the DSC 12 are displayed.

Two or more signal processing devices 10 of the present invention which perform different types of processing can also be interposed between the two devices 12 and 14. Also in this case, the signal processing devices 10 of the present invention recognize the device connected upstream, send downstream the information on the connected device, and emulate the upstream device.

In an example as shown in FIG. 1C, The DSC 12 is connected to a signal processing device 10S for performing setup, which in turn is connected to a signal processing device 10R for performing red-eye correction, which in turn is connected to the PC 14. As described above, the signal processing device 10S recognizes and emulates the upstream DSC 12, and sends to the downstream signal processing device 10R information indicating that the DSC 12 has been connected. In addition, the signal processing device 10R recognizes and emulates the upstream signal processing device OS, in other words, the DSC 12. Therefore, the signal processing device 10R and the signal processing device 10S both hide themselves in the file system of the DSC 12. As in the above case, the PC 14 simply recognizes that the DSC 12, namely an external storage device has been connected to the PC 14.

As described above, the signal processing device 10 causes the PC 14 operating the system to display folders and the like by a hierarchy conforming to the sequence in which connections were made. Therefore, when the DSC 12, the signal processing device 10S, the signal processing device 10R and the PC 14 are interconnected, a folder [ImageDeviceR] corresponding to the signal processing device 10R is displayed on the display of the PC 14, as schematically shown in FIG. 2B.

When the folder [ImageDeviceR] is opened, the folder [ImageDeviceS] corresponding to the signal processing device 10S is displayed. When this folder is then opened, the DSC 12 is displayed as a folder. When this folder is further opened, image files stored in the storage medium mounted to the DSC 12 are displayed.

As described below, the signal processing device 10 of the present invention automatically performs processing on image data and no user is aware of the operation performed.

In a system including the signal processing device 10 of the present invention, a file system by a hierarchy conforming to the sequence in which connections were made is displayed on the GUI of the PC 14 on which operations are made, which allows a user to confirm how many signal processing devices for performing what types of processing are interposed in which sequence. Accordingly, the user can more easily understand the overall system which includes the signal processing device 10 of the present invention, thus improving the ease of handling the system.

The signal processing device 10 of the present invention may also be configured to send to the PC 14 only the information indicating that the DSC 12 has been connected to the PC 14, so that only the folder of the DSC 12 can be displayed on the display 46 of the PC 14 as in the case where the PC 14 and the DSC 12 are interconnected in an ordinary manner.

In this case, the signal processing device 10 recognizes an upstream device connected to the signal processing device 10 but it is not necessary to transmit downstream the information on the signal processing device 10 having the upstream device connected thereto. It is only necessary to transmit downstream the information that the DSC 12 connected to the signal processing device 10 is located most upstream.

As shown in FIGS. 2A and 2B, the folder of the DSC 12 is opened and an image file stored therein is transferred from the DSC 12 to the PC 14 by a drag-and-drop operation in the state in which the stored image file is displayed, as in the case of the ordinary file transfer (copy or movement) from the DSC 12. In other words, a desired image file on the DSC 12 is dragged and dropped into, for example, the C drive folder of the PC 14. Plural image files may be transferred.

Alternatively, the signal processing device 10 of the present invention preferably emulates an upstream device so that files of the DSC 12 or the like can be opened not only by the operation on the desktop of the PC 14 or the like but also by a command of file readout by way of various kinds of software and sent to the application (PC 14).

In response to this, the signal processing device 10 reads out the image file transferred by a drag-and-drop operation from the storage medium of the DSC 12 and temporarily stores the image file in the memory 32. The DSP 30 and the CPU 28 then perform on the image data the processing that was set to perform thereon. The image file of the processed image data is then sent to the folder designated on the PC 14.

In the case where plural signal processing devices, for example, the signal processing device 10S for performing setup and the signal processing device 10R for performing red-eye correction are interposed, as shown in FIG. 1C, an image file is dragged and dropped from the folder of the DSC 12 into the signal processing device 10S, which reads out the image file, performs a setup on image data and sends the image file to the signal processing device 10R. The signal processing device 10R then performs red-eye correction on the received image data, and sends the image file which has undergone plural types of processing, to the folder designated on the PC 14.

As is clear from the above, the signal processing device 10 of the present invention is capable of sending image data having automatically undergone desired processing to a desired position of a desired device only by the user's operations including selection of the signal processing device 10 with which the desired processing is performed on the image data, insertion of the signal processing device 10 between the DSC 12 and the PC 14 for connection, and transfer of the image file using the user interface on the PC 14 or the like.

The image file is simply sent out when viewed from the DSC 12 and is simply received when viewed from the PC 14. The DSC 12 and the PC 14 have nothing to do with the image data processing.

Therefore, a user does not have to perform any special operations on the PC 14, or start or operate any applications for the image processing. Image data having undergone various types of processing can be obtained only with the operation that an image file is transferred using a mouse or the like. Even in the case where many images are to be processed, it is not necessary to read out image file after image file onto the application, and good operability can be achieved.

Since desired processing can be performed on image data only by connecting the signal processing device 10 which performs the desired processing, it is not necessary to install corresponding software on the PC 14 to perform the desired processing. In particular, even in the case where one wishes to perform plural types of processing, it suffices simply to connect a plurality of the signal processing devices 10. Therefore, it is not necessary to install plural types of software, or repeatedly operate the PC 14 or the like to perform the plural types of processing. The convenience and operability are thus significantly enhanced.

Since it is only necessary to interpose the signal processing device 10 between the PC 14 and the DSC 12, interconnect these devices, and transfer an image file, even an operator unskilled in the PC 14 can perform desired processing on image data by looking at a display on the desktop and performing an instinctive operation. In particular in the case of routine processing, a user can perform intended processing on image data without any particular instruction for processing if the signal processing device 10 is left connected. Reduction of workload and enhancement of convenience can be thus attained.

Only changing the cable connection makes it possible to easily and readily dealing with the case where plural PCs 14 and DSCs 12 are used.

In the embodiment described above, the processing on image data is performed in accordance with the transfer of the image file. However, this is not the sole case of the present invention.

For example, the following method is also applicable: when the DSC 12, the signal processing device 10 and the PC 14 are interconnected, image data that is stored on the storage medium installed in the DSC 12 is read out and is processed; the processed image data is then stored in a predetermined area of the signal processing device 10 of the present invention or the PC 14 and is transferred in accordance with the image file transfer by a drag-and-drop operation.

The signal processing device 10 of the present invention is not restricted to the case where all the image data passing therethrough are subjected to image data processing. When set and predetermined operations are performed as appropriate, the image data may be sent downstream without performing any image data processing.

For example, if the OS used is Windows™, when the image file is transferred by clicking the right-button of the mouse, or when the image file is transferred with the control key pressed down (this works on MacOS™ as well), the signal processing device 10 may not perform the processing on the image data.

The destination to which the image file will be transferred may be set appropriately depending on the image processing to be performed and the like.

For example, in the case where the signal processing device 10 is the device for performing red-eye detection as described above, images where no red-eye effect occurs may be moved to a designated folder, and images where red-eye effect was detected may be moved to a specific folder for red-eye images. Alternatively, the images where no red-eye effect occurs may be moved to a designated folder as in the above, and the images where red-eye effect was detected may be stored in storage means of the signal processing device 10. Then, when the device capable of red-eye correction is connected downstream, the thus stored image data may be sent to this device.

As described above, it is possible to interpose two or more signal processing devices 10 of the present invention between the DSC 12 and the PC 14 and to interconnect these devices 10, 12 and 14 to thereby perform different types of processing. However, the image quality or efficiency may often be degraded (ox enhanced) depending on the image processing to be performed, processing method to be used, and the sequence in which the different types of processing is performed.

In order to deal with this problem, the signal processing device 10 of the present invention may store devices that are not to be connected upstream from the signal processing device 10 and those that are not to be connected downstream therefrom, so that, when the devices are interconnected in an undesirable sequence, indication on the display of the DSC 12 or PC 14, sound, or the like may be used to give a warning, or to suggest a better connection sequence.

In the embodiment described above, the signal processing device 10 of the present invention was interposed between the DSC 12 and the PC 14. However, the present invention is not restricted to this arrangement. The signal processing device 10 may also be interposed between various devices including a printer, and a reading device for a storage medium such as an xD Picture Card™, a SmartMedia™, or a CD-R.

For example, the signal processing device 10 may be interposed between the DSC 12 and a printer, between the PC 14 and the printer, between one of the PCs 14 and the other PC 14, between a reading device and the printer, between the reading device and the PC 14 so that processing can be performed on the image data received from the upstream device and the processed image data can be sent downstream. In other words, the signal processing device 10 of the present invention can be interposed between any types of devices which can constitute the image data (digital data) supply source, and the image data (digital data) destination.

In stead of interposing the signal processing device 10 between two devices, similar processing may be performed by regarding a folder in the PC 14 or another device as a virtual external storage device, as exemplified by the case where image data is received from the PC 14 and processed, and the processed image data is sent back to the same PC 14.

The signal processing device 10 of the present invention is interposed between the DSC 12 and the PC 14 or the like. However, a second embodiment of the present invention uses a so-called “adapter” for mounting, for example, an xD Picture Card™ or other such storage medium into a device having no slot compatible with this storage medium, such as the PC 14 which only has a slot for a PC card.

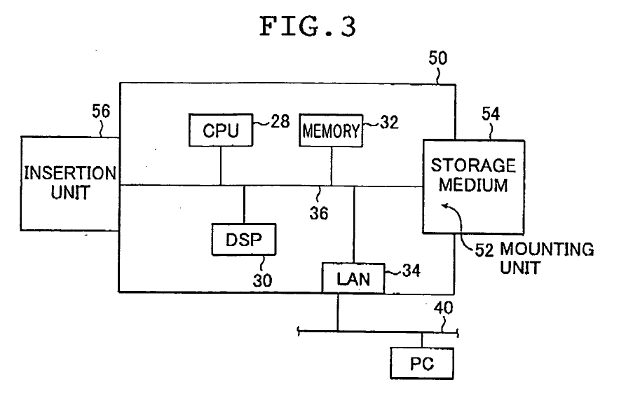

FIG. 3 shows a conceptual diagram of this embodiment. Since the embodiment shown in FIG. 3 has many identical components to those of the signal processing device 10, so that like components are identified by like numerals and different components will be mainly described below.

A signal processing device 50 shown in FIG. 3 is inserted into a (card) slot for a PC card of the PC 14 or another external device, with a storage medium 54 such as an xD Picture Card™, SmartMedia™, or Compact Flash™ being mounted thereon. In addition to the CPU 28, the DSP 30, the memory 32, and the LAN port 34, the signal processing device 50 also includes a medium mounting unit 52 where the storage medium 54 is mounted, and an insertion unit 56 which is inserted into the slot of the PC 14 or the like to connect to the PC 14 or the like. Those components are interconnected by the bus 36 as in the embodiment described above.

Except for their forms which are different from each other, the signal processing device 50 basically has the same operations as those of the signal processing device 10.

That is, when the storage medium 54 is mounted on the medium mounting unit 52 and the insertion unit 56 is inserted into the PC card slot of the PC 14 or the like, the signal processing device 50 emulates the storage medium 54, and hides itself in a file system. As in the above, when an image file is transferred by a drag-and-drop operation, the signal processing device 50 reads out the transferred image file from the storage medium 54, subjects the image data to image processing set in the signal processing device 50, and sends the processing image data from the insertion unit 56 to the PC 14 or the like. Therefore, as in the above, a user can process image data only by transferring an image file by the GUI or the like. Further, since the signal processing device 50 emulates the storage medium 54, the image data is simply sent out when viewed from the storage medium 54 and is simply received when viewed from the PC.

In the signal processing device 50 according to the second embodiment of the present invention, the device that is mounted on the mounting unit is not restricted to so-called “card media” including xD Picture Card™. Any type of storage medium can be used. The place where the insertion unit 56 is inserted is also not restricted to the card slot for the PC card. An insertion unit corresponding to any type of storage medium insertion unit (mounting unit) being set for the PC or a direct printer or the like is usable.

In the above-mentioned embodiments, the signal processing devices 10, 50 of the present invention perform processing on image data, but the data processed by the signal processing devices of the present invention is not restricted to image data. The signal processing devices can be used for processing various digital data such as voice data and text data (including codes).

For example, examples of voice data processing include noise elimination, format conversion, size conversion, and application of surround effects. In addition to these types of voice data processing, another preferable example is to add information based on data analysis in the case of voice data related to image data, for example by a method in which voice recognition is performed for text conversion to add text data to image data, or by another method in which voice recognition is performed to translate Japanese into English to add translated text as the data or the like. Examples of text data processing include various processing such as language conversion and Japanese kanji/kana conversion.

Detailed explanation has been given above regarding the signal processing device of the present invention, but the present invention is not restricted to the above-mentioned embodiments, and various improvements and modifications may be made without departing from the gist of the present invention.

1. A signal processing device, comprising:
a first interface for connecting the signal processing device to a first device serving as a supply source of digital data;
processing means for performing processing on the digital data;
a second interface for connecting the signal processing device to a second device serving as a supply destination of the digital data; and
emulating means for emulating the first device.

2. The signal processing device according to claim 1, further comprising:
means for recognizing the first device; and
means for sending information on the recognized first device to the second device,
wherein a graphical user interface for operating a system to which the signal processing device is connected displays a file structure by a hierarchy conforming to a sequence in which the first device, the signal processing device and the second device are connected.

3. The signal processing device according to claim 2, wherein in response to one of drag-and-drop on the graphical user interface and a data readout instruction given using the graphical user interface, said processing means performs the processing on the digital data.

4. The signal processing device according to claim 3, wherein said processing means does not perform the processing on the digital data for which a predetermined operation was performed at a time of one of the drag-and-drop and the data readout instruction.

5. The signal processing device according to claim 1, wherein a graphical user interface for operating a system to which the signal processing device is connected displays only a file structure of a device arranged most upstream in a direction in which the digital data is sent.

6. The signal processing device according to claim 5, wherein in response to one of drag-and-drop on the graphical user interface and a data readout instruction given using the graphical user interface, said processing means performs the processing on the digital data.

7. The signal processing device according to claim 6, wherein said processing means does not perform the processing on the digital data for which a predetermined operation was performed at a time of one of the drag-and-drop and the data readout instruction.

8. The signal processing device according to claim 1, wherein the processing on the digital data comprises at least one of a treatment performed on the digital data, and addition of information to the digital data according to results of analysis of the digital data.

9. The signal processing device according to claim 1, further comprising:
means for downloading processing software for the digital data from an external unit,
wherein said processing means uses the processing software to perform the processing on the digital data.

10. The signal processing device according to claim 1, further comprising:
mounting means for enabling a storage medium to be mounted and removed,
wherein said processing means uses information stored in the storage medium to perform the processing on the digital data.

11. A signal processing device, comprising:
a mounting unit for a storage medium that stores digital data;
an insertion unit for inserting the signal processing device into a slot which is provided to an external device and which corresponds to a storage device that is based on a standard different from said mounting unit;
processing means for reading out the digital data from the storage unit mounted on said mounting unit and performing processing on the read-out digital data;
means for outputting the processed digital data to said insertion unit; and
means for emulating the storage medium mounted on said mounting unit.

12. The signal processing device according to claim 11, wherein a file structure of the storage medium is displayed on a graphical user interface for operating a system into which the insertion unit is inserted.

13. The signal processing device according to claim 12, wherein in response to one of drag-and-drop on the graphical user interface and a data readout instruction given using the graphical user interface, said processing means performs the processing on the digital data.

14. The signal processing device according to claim 13, wherein said processing means does not perform the processing on digital data for which a predetermined operation was performed at a time of one of the drag-and-drop and the data readout instruction.

15. The signal processing device according to claim 14, wherein the processing on the digital data comprises at least one of a treatment performed on the digital data, and addition of information to the digital data according to results of analysis of the digital data.

16. The signal processing device according to claim 11, further comprising:
means for downloading processing software for the digital data from an external unit,
wherein said processing means uses the processing software to perform the processing on the digital data.

17. The signal processing device according to claim 11, further comprising:
mounting means for enabling the storage medium to be mounted and removed,
wherein said processing means uses information stored in the storage medium to perform the processing on the digital data.
